(19) United States
(12) Patent Application Publication
(10) Pub. No.: US 2026/0259007 A1
(43) Pub. Date: Sep. 3, 2026

(54) INSPECTION ASSEMBLY FOR A FURNACE ENVIRONMENT

(71) Applicant: Tallman Technologies Inc., Burlington (CA)

(72) Inventors: Michael J. STRELBISKY, Burlington (CA); Aaron Michael Conrad STRELBISKY, Burlington (CA); Majid ZAMANI, Burlington (CA)

(21) Appl. No.: 19/490,013

(22) PCT Filed: Jun. 7, 2024
(86) PCT No.: PCT/CA2024/050762

§ 371 Date: Dec. 4, 2025

Related U.S. Application Data
(60) Provisional application No. 63/472,111, filed on Jun. 9, 2023.

(51) Int. Cl. F27D 19/00; F27D 9/00; F27D 21/00; F27D 21/02

(52) U.S. Cl. CPC F27D 19/00; F27D 9/00; F27D 21/0014; F27D 21/02; F27D 2009/0008; F27D 2019/0068; F27D 2021/026

(57) ABSTRACT

An inspection assembly for obtaining preselected information in a furnace environment in a chamber in which a process material is subjected to a process The inspection assembly includes a barrel subassembly with coaxial inner and outer barrels, and an inspection device in the inner barrel, for detecting the preselected information. The inner barrel defines an inner bore in which the inspection device is at least partially positioned, and the inspection device defines an aperture in the inner bore through which the preselected information is detected. The inner and outer barrels define a outer annular space therebetween, through which one or more gases are directable. The outer annular space and the inner bore are in fluid communication with the chamber. The gases directed through the outer annular space form an outer annular gas stream coaxial with the inner bore upon exiting from the outer annular space, into the chamber.

### CROSS-REFERENCE TO RELATED APPLICATION

This application claims the benefit of U.S. Provisional Patent Application No. 63/472,111, filed on Jun. 9, 2023, the entirety of which provisional patent application is hereby incorporated herein by reference.

### FIELD OF THE INVENTION

The present invention is an inspection assembly for obtaining preselected information in a chamber in which a process ejecting high impact particles is underway and/or in which high temperatures are generated in connection with the process.

### BACKGROUND OF THE INVENTION

As is well known in the art, an operator may need to obtain information in real time about a process inside a chamber via a suitable device (e.g., a suitable camera) in a high particle impact environment in the chamber, in which particles may be directed toward the camera, at relatively high velocity. The high particle impact environment may be, for example, inside an electric arc furnace or a basic oxygen furnace during its operation. Inside the furnace, a wide variety of particles of varying size may be ejected at high velocity due to process reactions (e.g., from a steel bath), impacting the camera, or otherwise impeding observation of the steel bath or the walls of the chamber during operation.

High temperatures inside the electric arc furnace or the basic oxygen furnace also complicate inspection inside it. In these furnaces, both the high impact particles and the high temperature make observation or inspection of the process difficult. Typically, the high impact particles are relatively hot, and may be semi-solid. The high impact particles may tend to accumulate or agglomerate on exposed surfaces inside the furnace.

High-temperature environments are also found in a number of other furnaces, for example, in a reheating furnace (for hot rolling steel), or in a glass furnace. In some furnaces, e.g., reheating furnaces, high temperatures are generated in connection with the process in the chamber, with or without high impact particles. For purposes hereof, the temperatures in the high-temperature environment may be between approximately 100° C. and approximately 1,700° C.

The conventional cameras designed for use in these difficult environments (i.e., environments with high impact particles and/or high temperatures) are not designed for continuous observation. For instance, the conventional high-temperature cameras may be retracted after an image is obtained, to avoid overheating the camera, or the camera may be protected by a door or shutter, although these designs limit the images that are obtainable. Conventional high-temperature camera units are subject to damage by high impact particles, when not retracted or when not covered by a door.

Typically, the camera is located in a water-cooled jacket. This introduces a risk that water may be released therefrom into the furnace, which may be dangerous.

The known high-temperature camera units may provide for air to be blown across the camera lens, in an attempt to protect the lens. However, this arrangement does not prevent particles from impacting the camera.

If the prior art camera unit includes a shutter or door that may be closed to protect the camera, then when the door is closed, it may be impacted by high impact particles, which may accumulate to impede or prevent operation of the shutter device.

### SUMMARY OF THE INVENTION

For the foregoing reasons, there is a need for an inspection assembly for obtaining preselected information in a furnace environment in a chamber in which a process ejecting high impact particles and/or generating high temperatures is underway that overcomes or mitigates one or more of the defects or deficiencies of the prior art.

In its broad aspect, the invention provides an inspection assembly for obtaining preselected information in a furnace environment in a chamber in which a process material is subjected to a process. The inspection assembly includes one or more inspection devices for detecting the preselected information. The inspection device defines an aperture through which the preselected information is detectable.

The inspection assembly also includes a barrel subassembly extending between first and second ends thereof. The barrel subassembly includes an inner barrel having a first wall defining an inner bore, and a second wall located radially outwardly relative to the first wall. The barrel subassembly also includes an outer barrel positioned coaxially with the inner barrel, the outer barrel having an inside wall that defines one or more outer annular spaces between the second wall and the inside wall of the outer barrel. The outer annular space extends between outer upstream and outer downstream ends thereof.

The inspection device is located at least partially inside the inner barrel to at least partially align the aperture thereof with the inner bore, so that the preselected information is obtainable via the inspection device through the inner bore. The second end of the barrel subassembly is located to position the outer annular space at the outer downstream end thereof and the inner bore in fluid communication with the chamber.

The barrel subassembly is configured for directing a first portion of one or more gases through the outer annular space at at least one preselected velocity to cool the inspection assembly. The first portion of the one or more gases forms an outer annular gas stream coaxial with the inner bore upon exiting from the outer downstream end, into the chamber. The preselected information is obtainable via the aperture and through the inner bore.

In another of its aspects, the inspection assembly defines one or more inner annular spaces between the first wall and the inspection device that extends between inner upstream and inner downstream ends thereof. The second end of the barrel subassembly is located to position the inner annular space in fluid communication at the inner downstream end thereof with the chamber. The barrel subassembly is configured for directing a second portion of the one or more gases through the inner annular space at the preselected velocity to cool the inspection assembly. The second portion of the one or more gases forms an inner annular gas stream coaxial with the inner bore upon exiting from the inner downstream end, into the chamber.

### BRIEF DESCRIPTION OF THE DRAWINGS

The invention will be better understood with reference to the attached drawings, in which:

FIG. 1 is an isometric view of an embodiment of an inspection assembly of the invention;

FIG. 2 is a side view of the inspection assembly of FIG. 1;

FIG. 3 is an end view of an output end of the inspection assembly;

FIG. 4 is a longitudinal section of the inspection assembly of FIGS. 1-3, taken as indicated in FIG. 3;

FIG. 5A is another longitudinal section of the inspection assembly of FIGS. 1-3, taken as indicated in FIG. 3;

FIG. 5B is a portion of the longitudinal section of FIG. 5A drawn at a larger scale;

FIG. 5C is a view of the portion of FIG. 5B illustrating alternative embodiments of the invention;

FIG. 6 is an isometric view of a cross-section of the inspection assembly of FIGS. 1-3, taken as indicated in FIG. 2, drawn at a smaller scale;

FIG. 7A is an isometric view of another cross-section of the inspection assembly of FIGS. 1-3, taken as indicated in FIG. 2;

FIG. 7B is an isometric view of another cross-section of the inspection assembly of FIGS. 1-3, taken as indicated FIG. 2;

FIG. 8A is an isometric rear side view of an embodiment of a panel assembly of the invention, drawn at a smaller scale;

FIG. 8B is a rear side view of the panel assembly of FIG. 8A;

FIG. 8C is a front side view of the panel assembly of FIGS. 8A and 8B;

FIG. 9 is a schematic illustration of an embodiment of a system of the invention;

FIG. 10A is a partially cut away isometric view of an interior of an electric arc furnace with embodiments of the inspection assemblies of the invention mounted in a wall thereof, drawn at a smaller scale;

FIG. 10B is a portion of the interior of the electric arc furnace of FIG. 10A, drawn at a larger scale; and

FIG. 11 is a cross-section of a basic oxygen furnace with embodiments of the inspection assemblies of the invention mounted therein, drawn at a smaller scale.

### DETAILED DESCRIPTION

For the purposes hereof, a furnace environment in a chamber 21 in which a process material 10 is subjected to a process is an environment in which (i) high impact particles are ejected from the process material (i.e., the furnace environment is a high particle impact environment), and/or (ii) high temperatures are generated in connection with the process in the chamber (i.e., the furnace environment is a high-temperature environment). It will be understood that the process material may include one or more of solids, liquids, and/or gases.

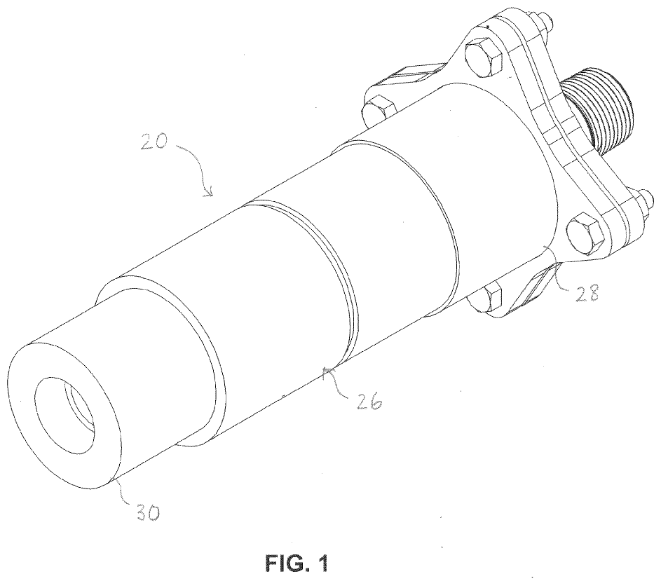

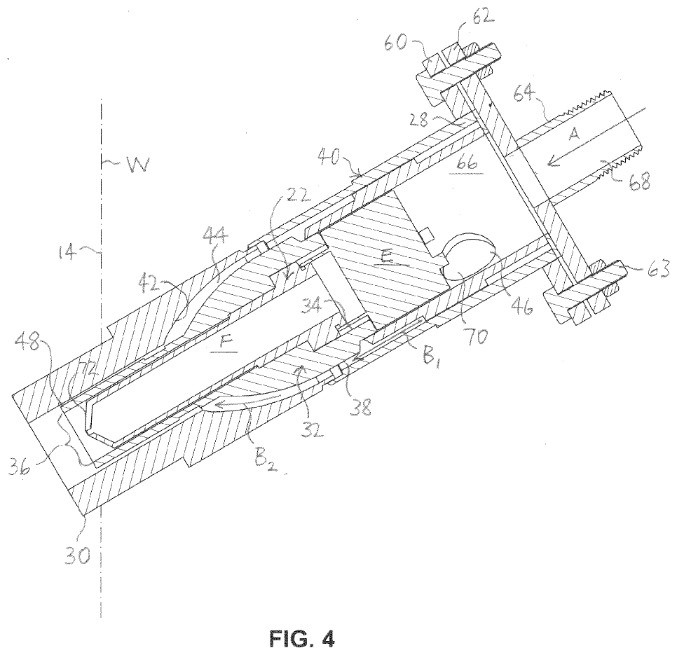

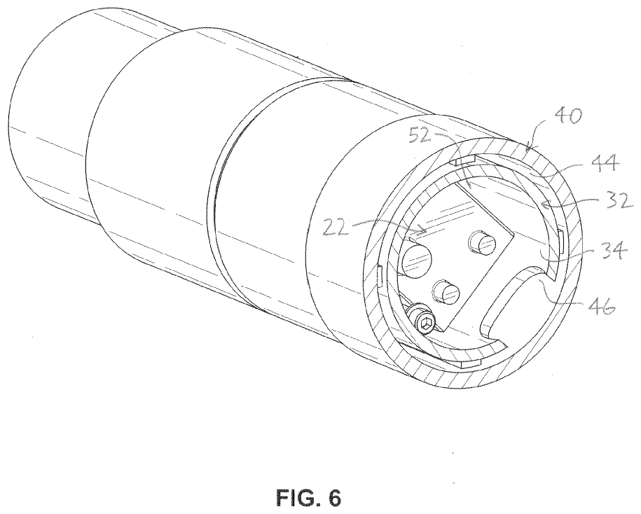

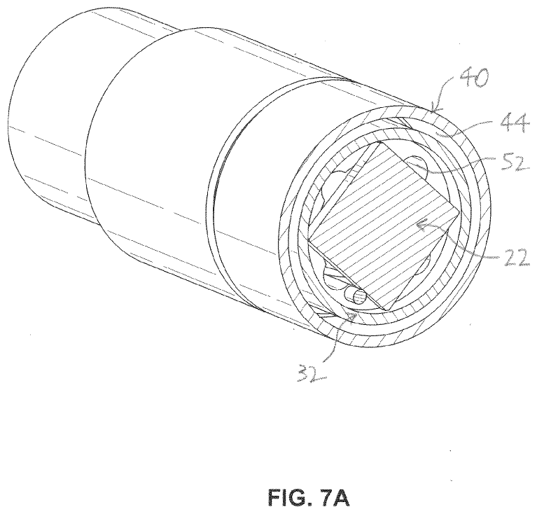

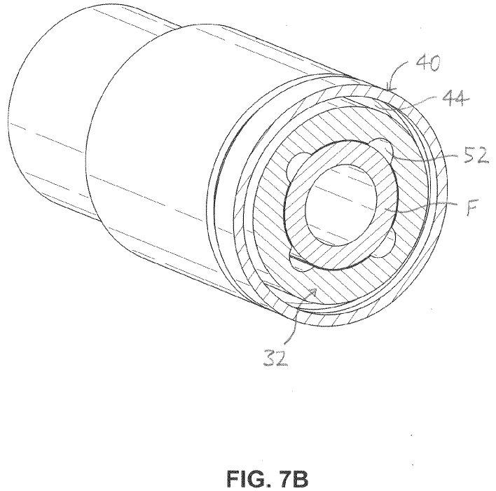

In the attached drawings, like reference numerals designate corresponding elements throughout. Reference is first made to FIGS. 1-7C to describe an embodiment of an inspection assembly in accordance with the invention indicated generally by the numeral 20. As will be described, in one embodiment, the inspection assembly preferably is for obtaining preselected information in the furnace environment in the chamber 21 (FIG. 4). As can be seen in FIG. 4, in one embodiment, the inspection assembly 20 preferably is mounted in a wall “W” that partially defines the chamber 21.

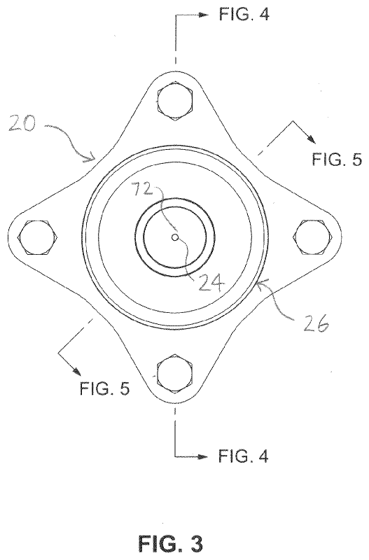

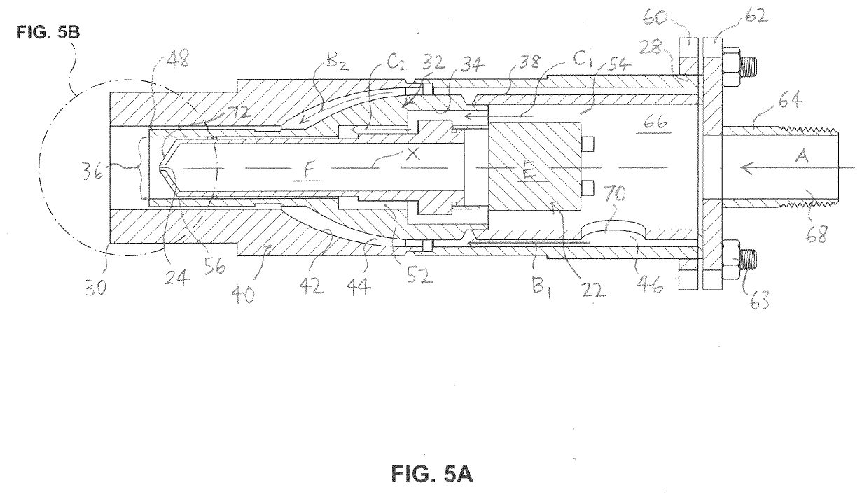

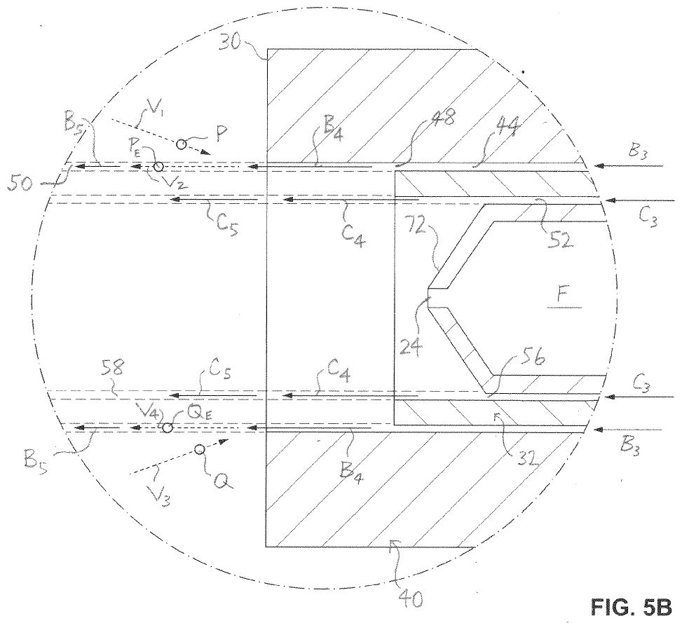

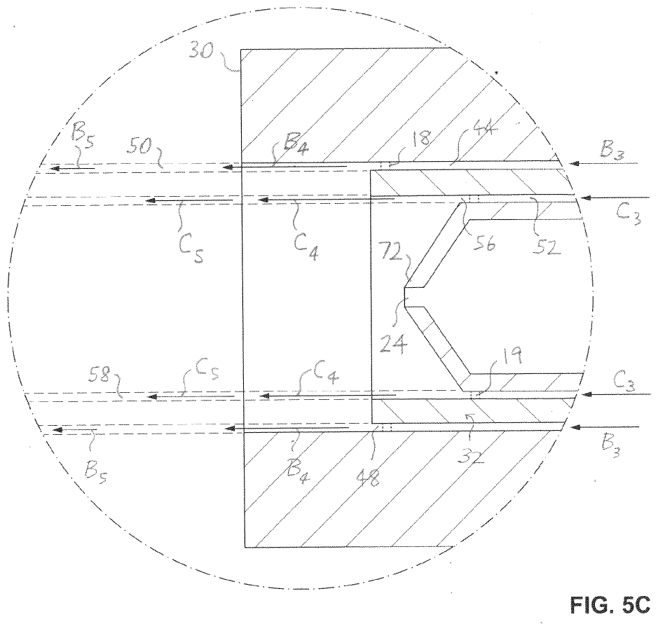

In one embodiment, the inspection assembly 20 preferably includes one or more inspection devices 22 for detecting the preselected information (FIGS. 4, 5A). Preferably, the inspection device 22 defines an aperture 24 through which the preselected information is detectable by the inspection device 22 (FIG. 3).

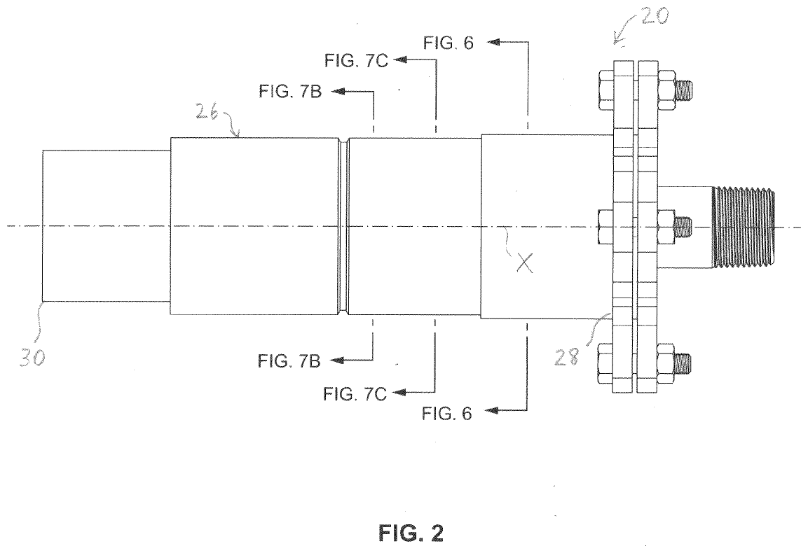

As can be seen in FIGS. 1-7C, the inspection assembly 20 preferably also includes a barrel subassembly 26 extending between first and second ends 28, 30 thereof (FIGS. 1, 2). In one embodiment, the barrel subassembly 26 preferably includes an inner barrel 32 having a first wall 34 defining an inner bore 36, and a second wall 38 generally located radially outwardly relative to the first wall 34 (FIGS. 4, 5A). Preferably, the barrel subassembly 26 also includes an outer barrel 40 positioned coaxially with the inner barrel 32. The outer barrel 40 preferably has an inside wall 42 that defines one or more outer annular spaces 44 (FIGS. 4, 5A, 5B, 6, 7A, 7B) between the second wall 38 and the inside wall 42 of the outer barrel 40. The outer annular space 44 preferably extends between an outer upstream end 46 and an outer downstream end 48 thereof.

The axis of the inner and outer barrels 32, 40 is identified in FIG. 2 by reference character “X”. The inner bore 36 is also coaxial with the axis “X” (FIG. 4).

Preferably, the inspection device 22 is located at least partially inside the inner barrel 32, to at least partially align the aperture 24 thereof with the inner bore 36. As will be described, the preselected information preferably is obtainable via the inspection device 22 through the inner bore 36.

In the example illustrated in FIGS. 4, 5A, and 5B, an outer end 72 of the lens portion “F” includes and at least partially defines the aperture 24.

As will also be described, the second end 30 of the barrel subassembly 26 preferably is located to position the outer annular space 44 and the inner bore 36 in fluid communication with the chamber 21. As can be seen in FIG. 4, for example, in one embodiment, the barrel subassembly 26 may be mounted in a wall “W” that partially defines the chamber 21 so that the second end 30 is in the chamber 21. The outer end 72 is exposed to the chamber 21, to enable the preselected information to be obtained from the chamber 21, via the aperture 24. From the foregoing, it can be seen that the outer end 72 is in fluid communication with and exposed to the furnace environment in the chamber 21.

Preferably, the barrel subassembly 26 is configured for directing a first portion of one or more gases through the outer annular space 44 at one or more preselected velocities to cool the inspection assembly 20. The one or more gases preferably form an outer annular gas stream 50 coaxial with the inner bore 36 upon exiting from the outer downstream end 48, so that the preselected information is obtainable via the aperture 24 and through the inner bore 36.

As will be described, where high impact particles are ejected due to the process into the furnace environment, the first annular gas stream 50 at least partially impedes the high impact particles from entering into the inner bore 36. In this way, the first annular gas stream 50 at least partially impedes the high impact particles from impacting the outer end 72, and/or the aperture 24.

In one embodiment, the inspection assembly 20 preferably also defines one or more inner annular spaces 52 between the first wall 34 and the inspection device 22 extending between an inner upstream end 54 and an inner downstream end 56 thereof (FIGS. 4, 5A, 5B, 6, 7A, 7B). The second end 30 of the barrel subassembly 26 preferably is located to position the inner annular space 52 in fluid communication with the chamber 21 (FIG. 4).

Preferably, the barrel subassembly 26 is configured for directing a second portion of the one or more gases through the inner annular space 52 at the preselected velocity to cool the inspection assembly 22. The one or more gases that are directed through the inner annular space 52 preferably form a second annular gas stream 58 coaxial with the inner bore 36 upon exiting from the inner downstream end 56, so that the preselected information is obtainable via the aperture 24 and through the inner bore 36.

As will also be described, where high impact particles are ejected due to the process into the furnace environment in the chamber 21, the inner annular gas stream 58 may at least partially impede the high impact particles from entering into the inner bore 36.

In the illustrated example, e.g., in FIGS. 4 and 5A, the inspection device 22 is a camera that includes a body portion “E” and a lens portion “F”. However, it will be understood that the inspection device 22 may be any suitable device, depending on the preselected information that is sought. For example, the inspection device 22 may be a camera, a microwave unit, a laser, or a temperature sensor. Those skilled in the art would be aware that the inspection devices generally utilize an unobstructed line-of-sight to a location of interest inside the chamber in order to detect the preselected information.

From the foregoing, those skilled in the art would appreciate that, via the inspection assembly 20, the preselected information is obtainable from surfaces inside the chamber 21, e.g., a surface 12 of the process material 10, and/or one or more surfaces 14 of the wall “W”.

Those skilled in the art would appreciate that the lens portion “F” preferably includes means for allowing the preselected information detected via the aperture 24 to be transmitted to or accessible by, the body portion “E”. For instance, the lens portion “F” may include one or more lenses (not shown), positioned as required in relation to the aperture 24. It will be understood that lenses and other internal elements of the lens portion “F” are omitted from FIGS. 4, 5A, 5B, and 7B, for clarity of illustration.

As can be seen in FIGS. 4 and 5A, in one embodiment, one or more gases preferably are directed into the inspection assembly 20 at the one or more preselected velocities, to enter into the barrel subassembly 26 at the first end 28 thereof. In the example illustrated, the barrel subassembly 26 preferably includes a first plate 60 at the first end 28, and the inspection assembly 20 preferably also includes a second plate 62 securable to the first plate 60 (FIGS. 4, 5A). The first plate 60 preferably is secured to the outer barrel 40 in any suitable manner. Preferably, the first and second plates 60, 62 are secured together by suitable fasteners 63. As illustrated, the inspection assembly 20 preferably includes a fitting 64 mounted to the second plate 62 for connection to a conduit (not shown) through which the one or more gases are directed into the inspection assembly 20 (FIGS. 4, 5A). Those skilled in the art would appreciate that any suitable gas, or gases, may be directed into the inspection assembly 20 via the fitting 64.

It will be understood that the fitting 64 is formed for cooperation with the conduit (e.g., a delivery pipe or tubing) (not shown) through which the one or more gases are directed at the one or more preselected velocities, from a source thereof (not shown). For instance, in the example illustrated, the fitting 64 is externally threaded, for threadable engagement with a mating fitting (not shown) on the delivery pipe or tubing, for securing the delivery pipe and the fitting together. Those skilled in the art would be aware of various suitable means for securing the delivery pipe and the fitting together.

In one embodiment, the inner barrel 32 preferably defines an inlet cavity 66 proximal to the first end 28 of the barrel subassembly 26 (FIGS. 4, 5A). The inlet cavity 66 preferably is in fluid communication with a channel 68 defined in the fitting 64. The one or more gases are preferably directed at the one or more preselected velocities through the channel 68 into the inlet cavity 66, as schematically represented by arrow “A” (FIGS. 4, 5A).

As can be seen in FIGS. 4 and 5A, in one embodiment, the inner barrel 32 preferably defines an opening 70 through which the inlet cavity 66 and the outer annular space 44 are in fluid communication. The outer upstream end 46 of the outer annular space 44 is located at the opening 70.

Alternatively, the inner barrel 32 may include a number of openings that permit fluid communication between the inlet cavity 66 and the outer annular space 44.

As noted above, in one embodiment, the one or more gases that are directed into the inspection assembly 20 at the one or more preselected velocities are partly directed into the outer annular space 44, and partly directed into the inner annular space 52. Specifically, the first portion of the one or more gases that are directed into the inlet cavity 66 preferably is directed into the outer annular space 44 at the outer upstream end 46, and travels through the outer annular space 44 to the outer downstream end 48, as schematically represented by arrows “B₁”, “B₂” (FIGS. 4, 5A). As noted above, upon the first portion of the one or more gases exiting from the outer downstream end 48, the first portion of the one or more gases forms the outer annular gas stream 50 (FIG. 5B).

In FIG. 5B, arrows indicating the direction of flow of the first portion of the one or more gases through the outer annular space 44 are identified by reference character “B₃”. Arrows “B₄”, “B₅” indicate the direction of flow of the one or more gases in the outer annular gas stream 50.

The one or more preselected velocities may be supersonic, or approximately supersonic, i.e., subsonic, or transonic. Accordingly, the one or more gases exiting the outer annular space 44 at the outer downstream end 48 preferably are travelling at a supersonic, or approximately supersonic, velocity.

It will be understood that the outer annular gas stream 50 has a generally cylindrical shape initially, upon exiting from the outer downstream end 48, and is coaxial with the inner bore 36 (FIG. 5B). Upon exiting at the outer downstream end 48, the outer annular gas stream 50 defines a substantially cylindrical core volume therein that is coaxial with the inner bore 36. However, it is believed that the outer annular gas stream 50 retains a generally annular shape for only a short distance upon exiting from the outer downstream end 48.

The second portion of the one or more gases that are directed into the inlet cavity 66 preferably is directed into the inner annular space 52 at the inner upstream end 54, and travels through the inner annular space 52 to the inner downstream end 56, as schematically represented by arrows “C₁”, “C₂” (FIGS. 4, 5A). As noted above, upon the second portion of the one or more gases exiting from the inner downstream end 56, the second portion of the one or more gases forms the inner annular gas stream 58 (FIG. 5B).

In FIG. 5B, arrows indicating the direction of flow of the second portion of the one or more gases through the inner annular space 52 are identified by reference character “C₃”. Arrows “C₄” indicate the direction of flow of the second portion of the one or more gases through the inner annular space 52 and exiting therefrom, to form the inner annular gas stream 58. Arrows “C₅” in FIG. 5B indicate the direction of flow of the one or more gases in the inner annular gas stream 58.

It will be understood that the inner annular gas stream 58 also has a generally cylindrical hollow shape initially, upon exiting from the inner downstream end 56, and is coaxial with the inner bore 36 (FIG. 5B). Upon exiting at the inner downstream end 56, the inner annular gas stream 58 defines a substantially cylindrical core volume therein that is coaxial with the inner bore 36. However, it is believed that the inner annular gas stream 58 has a generally cylindrical shape for only a short distance upon exiting from the inner downstream end 56.

As an example, a high impact particle “P” is shown in FIG. 5B travelling at a velocity “V₁” toward the inner bore 36. It will be understood that the particle “P” is a high impact particle, ejected from process material 10 in the chamber 21, during the process to which the process material is subjected. When the particle's trajectory intersects one or both of the outer and inner annular gas streams 50, 58, the direction of movement of the particle “P” is changed, so that the high impact particle “P” does not enter into the inner bore 36. The high impact particles may be deflected or pushed away from the inner bore 36 by the first annular gas stream 50, and/or the second annular gas stream 58. It is believed that, in at least some instances, the particle is entrained by one of the outer and inner annular gas streams 50, 58.

In the examples illustrated in FIG. 5B, the high impact particles are shown as being entrained. One high impact particle prior to entrainment is identified by reference character “P”. For clarity of illustration, the entrained particle “P” is identified in FIG. 5B by reference character “P_{E}”. The direction of movement of the entrained particle “P_{E}” is represented by arrow “V₂”.

Those skilled in the art would appreciate that a very large number of particles may be ejected inside a chamber from the process material outwardly, i.e., generally toward the walls and roof of the chamber 21. However, only two examples of high impact particles, “P” and “Q”, are illustrated in FIG. 5B, for clarity of illustration. As illustrated in FIG. 5B, the high impact particle “Q” is directed toward the inner bore 36 while travelling at velocity “V₃”. In this example, this particle, after entrainment, is identified in FIG. 5B by reference character “Q_{E}”, and its direction of movement after entrainment is indicated by arrow “V₄”.

Those skilled in the art would appreciate that, in the event that a high impact particle is not entrained or deflected by the outer annular stream 50, the high impact particle may be entrained or deflected by the inner annular gas stream 58.

It will be understood that the one or more gases flowing through the annular spaces 44, 52 at supersonic velocities (or approximately supersonic velocities) cool the barrel subassembly 26 as the gases flow through the annular spaces 44, 52. The gases flowing through the annular spaces 44, 52 also cool the inspection device 22.

When the one or more gases are directed through the annular spaces 44, 52 under ideal conditions (i.e., at a design gas flow rate and pressure), the supersonic or approximately supersonic gases cool the barrel subassembly 26 and the inspection device 22 and create ideal supersonic or approximately supersonic annular jets (i.e., the annular gas streams 50, 58) that at least partially impede the high impact particles from reaching the inner bore 36. As a result, the high impact particles are substantially prevented from engaging the inspection device 22. In particular, the high impact particles are substantially prevented from striking the outer end 72 of the lens portion “F” (i.e., where they may otherwise accumulate) and from attaching to or damaging the lens portion “F” at the aperture 24.

When the one or more gases are directed through the annular spaces 44, 52 under non-ideal conditions (i.e., not at the design gas flow rate and pressure), the one or more gases will still cool the barrel subassembly 26 and the inspection device 22. It is believed that shockwaves that result from the non-ideal conditions will also substantially impede the high impact particles from entering the inner bore 36.

Those skilled in the art would appreciate that the one or more gases that are directed through the annular spaces 44, 52 at supersonic or approximately supersonic velocities, sometimes referred to hereinafter as “shrouding gases”, may be any suitable gas or mixture of gases.

As noted above, in use, the annular gas streams 50, 58 that exit the annular spaces 44, 52 at the downstream ends 48, 56 respectively are directed into the chamber 21. Depending on the circumstances, it is possible that the limited cooling that results in the chamber 21, from the flow of the annular gas streams 50, 58 of the shrouding gases into the chamber 21, may have a detrimental effect on the process (e.g., steelmaking) that is underway in the chamber 21, by lowering the temperature of the process.

If the annular gas streams 50, 58 have such detrimental effect on the process in the chamber 21, then in an alternative embodiment, the one or more gases directed into the annular spaces 44, 52 may include both (i) one or more shrouding gases, and (ii) one or more reactive gases. As noted above, the shrouding gases are the gas or gases that are directed through the annular spaces 44, 52 to cool the barrel subassembly and the inspection device, and to shield the inner bore 36 upon exiting at the downstream ends 48, 56.

The reactive gases are combustible, and they are included so that they may combust upon exiting the annular spaces 44, 52, to provide heat to the process in the chamber that counterbalances the cooling effect of the shrouding gases. For example, the shrouding gases may be air, and the reactive gas or gases may be natural gas. Accordingly, in this example, the one or more gases exiting the annular spaces 44, 52 to form the respective annular gas streams 50, 58 may be air, and natural gas.

Accordingly, in this embodiment, upon the annular gas streams 50, 58 exiting the respective annular spaces 44, 52, the reactive gas therein combusts in the chamber 21. In these circumstances, the cooling effects in the chamber 21 of the shrouding gas in the annular gas streams 50, 58 are mitigated by the combustion of the reactive gases in the annular gas streams, in the chamber.

If the combustion of the reactive gas in the annular gas streams 50, 58 impedes or prevents the inspection device 22 from detecting the preselected information, then the reactive gas may be included in the gases directed through the annular spaces 44, 52 only intermittently.

It will be understood that the supersonic or approximately supersonic annular gas flow of the one or more shrouding gases through the annular spaces 44, 52 cools the electronic components in the body portion “E” of the inspection device 22, and the lens portion “F”, as well as the barrel subassembly 26. Because of this, it is not necessary to retract the inspection assembly 20 from time to time to cool it, unlike certain of the prior art camera assemblies. The supersonic or approximately supersonic annular gas streams provide sufficient cooling that the inspection assembly 20 can stay in the hot environment indefinitely.

As can be seen in FIGS. 4 and 5A, in one embodiment, the inner bore 36 of the inner barrel 32 preferably varies in its diameter over the length of the inner barrel 32. In the example that is illustrated, the inner bore 36 is larger toward the first end 28 in order to accommodate the body portion “E” of the inspection device 22, and the lens portion “F” fits into a narrower part of the inner bore 36 toward the second end 30.

The annular gas streams 50, 58 prevent the high impact particles (if present in the furnace environment) that are moving inside the chamber 21 from entering the inner bore 36, and, to an extent, clear high impact particles proximal to the end 30 of the barrel subassembly out of the inspection device's field of view. As a result, due to the outer and inner annular gas streams 50, 58, the inspection device 22 may detect the preselected information from inside the chamber 21 when required.

It will be understood that the flow of the one or more gases through the outer annular space 44, or the flow of the one or more gases through the inner annular space 52, may be limited or prevented, for example, if it is desired to limit the gases exiting from the outer downstream end 48, or from the inner downstream end 56. Those skilled in the art would appreciate that the flow of the gases through the outer annular space 44 or through the inner annular space 52 may be prevented by using any suitable means. For instance, as illustrated in FIG. 5C, a first plug element 18 may be positioned in the outer annular space 44, if it is desired to allow only the inner annular gas stream 58 to be directed into the chamber 21. Alternatively, and also as illustrated in FIG. 5C, a second plug element 19 may be positioned in the inner annular space 52, if it is desired to allow only the outer annular gas stream 50 to be directed into the chamber 21.

It will be understood that in FIG. 5C, two incompatible alternative arrangements are illustrated that would not be utilized at the same time. For example, if the first plug element 18 is positioned in the outer annular space 44, then the one or more gases are prevented by the first plug element 18 from moving through the outer annular space 44 as schematically represented by arrows “B₃”, “B₄”, and “B₅”. In this situation, the one or more gases are only allowed to flow through the inner annular space 52 and exit at the inner downstream end 56, as schematically represented by arrows “C₃”, “C₄”, and “C₅”.

Alternatively, if the second plug element 19 is positioned in the inner annular space 52, then the one or more gases are prevented by the second plug element 19 from moving through the inner annular space 52 as schematically represented by arrows “C₃”, “C₄”, and “C₅”. In this situation, the one or more gases are only allowed to flow through the outer annular space 44 and exit at the outer downstream end 48, as schematically represented by arrows “B₃”, “B₄”, and “B₅”.

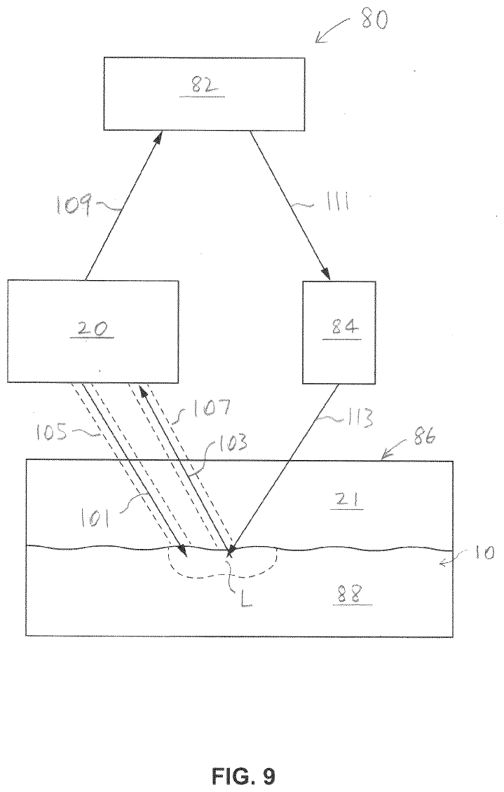

In one embodiment, a system 80 is provided for modifying a process to which the process material 10 is subjected in a furnace environment in the chamber 21, to adjust one or more actual values of one or more preselected parameters of the process to a predetermined acceptable range of values of the preselected parameter(s) (FIG. 9). As noted above, the process material may be solid, liquid, gaseous or mixtures thereof, and may include semi-solid (partially melted) material. For instance, the process material 10 may include a steel bath, e.g., in an electric arc furnace or in a basic oxygen furnace, and/or slag thereon or therein, as will be described. As can be seen in FIG. 9, in one embodiment, the system 80 preferably includes one or more inspection assemblies 20, a processor 82, and one or more injector assemblies 84.

The actual value of a preselected parameter is the value of that parameter as obtained (or measured) by the inspection assembly. In general, the actual value may be the preselected information sought to be obtained via the inspection assembly 20. For instance, where the preselected parameter of interest is a temperature of a surface of the process material 10, then the actual value of that parameter is the actual temperature of the surface, as determined via the inspection assembly. If the surface temperature's accepted range of values is, e.g., 1,500° C. to 1,700° C., and the actual (observed or measured) value is 1,400° C., then the system 80 preferably takes steps to increase the temperature of the surface of the process material to a temperature that is within the accepted range of values thereof.

The processor 82 is for processing the preselected information (i.e., the actual values) to determine, based on the preselected information, whether the actual values of one or more of the preselected parameters of the process are within the predetermined acceptable ranges of values thereof.

If the actual value of a particular preselected parameter is not within the predetermined acceptable range of values thereof, then the processor 82 preferably determines a selected amount of a selected injection agent to be injected into the process material to adjust or modify the actual value to the predetermined acceptable range of values thereof.

Each of the injector assemblies 84 preferably is configured for injecting the selected amount of the selected injection agent into the process material to adjust the actual value of the preselected parameter to the acceptable range of values thereof.

Those skilled in the art would appreciate that, depending on the circumstances, the adjustment effected by injection of the selected amount of the selected injection agent may adjust the preselected parameter to, or toward, the acceptable range of values thereof. The adjustment results in a modified value of the parameter, however, the modified value may not be within the acceptable range of values thereof. For example, depending on the circumstances, an injection of the selected amount may adjust the actual value of the preselected parameter only part of the extent necessary to bring the actual value within the acceptable range of values thereof. Another injection or injections may be needed. Also, while the process is underway, because the process is dynamic, a variety of factors may result in the adjustment not achieving the desired result, i.e., the modified value may not be within the predetermined acceptable range of values thereof. For the purposes hereof, it will be understood that adjustment of an actual value of a parameter “to” a predetermined acceptable range of values for that parameter includes both (i) adjusting the actual value of the parameter inside the chamber to be within the predetermined acceptable range of values, and (ii) adjusting the actual value toward the predetermined acceptable range of values.

From the foregoing, it can be seen that, because preselected information about a process that is underway inside the chamber 21 is obtainable via the inspection assembly 20, with the system 80, steps may be taken to optimize the process in real time, or substantially in real time. As noted above, the system 80 preferably includes the processor 82. The preselected information (e.g., an actual or measured value of a preselected parameter), once obtained, preferably is analyzed by the processor 82 with a view to determining whether the actual values of one or more preselected parameters of the process are within their respective acceptable ranges of values. Based on the preselected information obtained by the inspection device 22 and transmitted to the processor 80, adjustments may be made to the process (in real time, or substantially in real time), to change the actual or measured values of the preselected parameters inside the chamber, to cause the actual values after adjustment to be within the predetermined acceptable range of values thereof for optimizing the process inside the chamber 21.

As noted above, the system 80 preferably also includes one or more injector assemblies 84, which preferably are controlled (directly or indirectly) by the processor 82. For example, the injector assembly 84 may include a controller (for causing the injection agent to be injected) that is controlled via signals transmitted to it by the processor. In effect, adjustments to the process may be made via the injector assemblies 84. If a particular preselected parameter has an actual or measured value that is outside the acceptable range of values thereof, then the processor 82 determines a selected amount of a selected injection agent that is required to be injected into the process material to adjust the value of that preselected parameter to the acceptable range of values thereof.

For example, if the selected information that is obtained indicates that the actual temperature of the surface of the steel bath (i.e., the process material) is below the acceptable range of values thereof, then the processor 82 transmits a suitable signal to cause the one or more injector assemblies 84 to inject the selected amount of the selected injection agent (e.g., oxygen) into the process material, to increase the temperature to the acceptable range of values thereof. As noted above, however, due to the dynamic nature of the process, the adjustment may not cause the actual value of the parameter after adjustment to be within the predetermined acceptable range thereof, and further adjustment may be needed. In order to address fluctuations in the values of the parameters of interest, the process preferably is monitored frequently.

In one embodiment, the inspection assembly 20 may be used for substantially continuous real-time monitoring of the process in the chamber 21. It will be understood that repeated adjustments may be effected via the one or more injector assemblies 84 while the process is underway.

The preselected information that is obtained by the inspection assembly 20 may be transmitted or otherwise conveyed to the processor 82 by any suitable means (not shown). For example, the preselected information may be transmitted wirelessly to the processor 82, or via a hardwired connection. Similarly, control signals generated by the processor 82 may be transmitted to the one or more injector assemblies 84 (i.e., to controllers thereof) via any suitable means.

It will be understood that the processor 82 preferably is configured to analyze the preselected information that is obtained by the inspection device 22 and to determine changes to the actual or measured values of the preselected parameters of the process that will change the values thereof inside the chamber in order to optimize the process that is underway in the chamber 21, or that will lead to optimization of the process. The processor 82 is also configured to select the injection agent, to determine the amount of the injection agent needed to be injected to effect an improvement (adjustment) in the value of the preselected parameter to (or toward) the acceptable range of values thereof, and to control the one or more injection assemblies 84 to inject the injection agent, to cause the actual value of the preselected parameter inside the chamber to be within the acceptable range of values thereof.

It will be understood that the procedure preferably is repeated as appropriate, until the measured or actual values of the preselected parameter inside the chamber are within the predetermined acceptable range of values thereof. For instance, after the injection agent has been injected, the measured value inside the chamber that has been modified (due to the injection agent) preferably is measured or observed again, and the modified value is compared to the predetermined acceptable range of values. From the foregoing, it can be seen that the procedure of (i) observing or measuring to obtain the preselected information, (ii) comparing the actual or modified value of a parameter to the predetermined acceptable range of values thereof, (iii) determining an injection agent and amount thereof to adjust the actual value in the chamber to or toward the predetermined acceptable range of values of the parameter, and (iv) injecting the injection agent to cause a desired change in the actual value, may be and preferably is repeated while the process continues in the chamber.

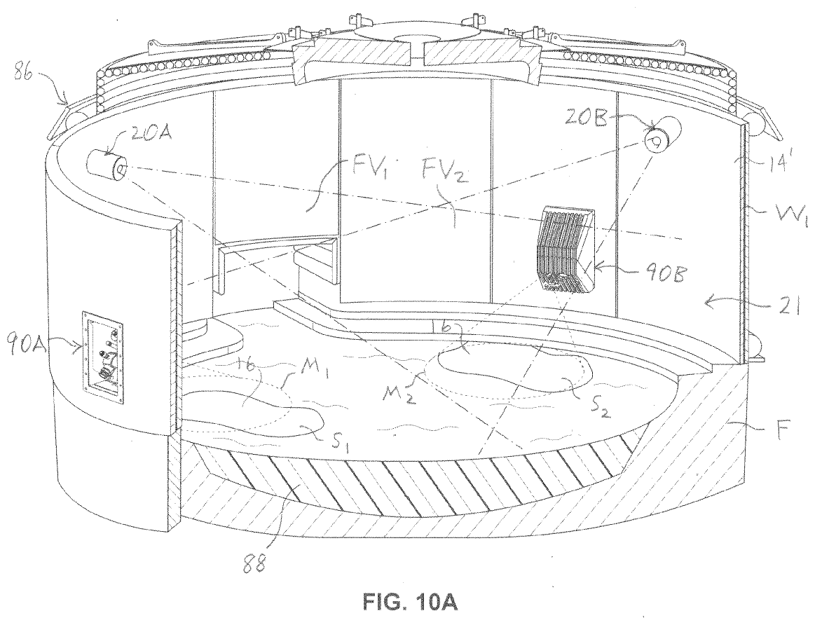

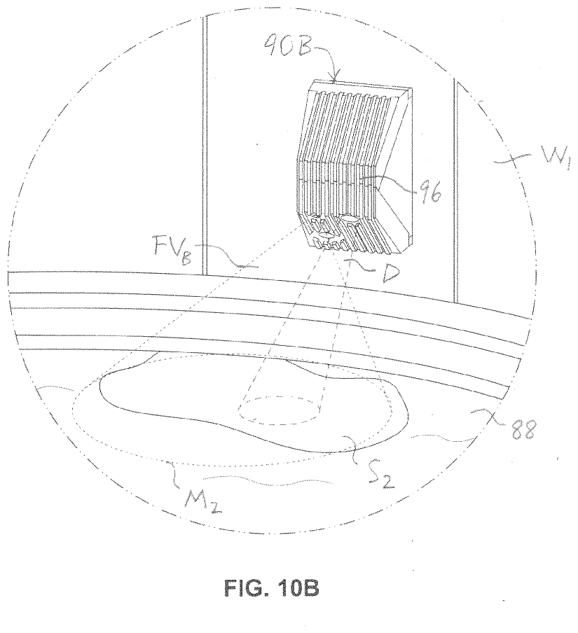

An example of a chamber 21 from which the inspection assembly 20 may obtain preselected information is illustrated in FIGS. 10A and 10B. In FIG. 10A, the chamber 21 inside an electric arc furnace 86 is partially defined by a wall “W₁” and a floor “F”. As illustrated in FIGS. 10A and 10B, a steel bath 88 (the process material) is located in the furnace 86, i.e., the process of steelmaking is underway in the chamber 21.

It will be understood that a number of elements of the electric arc furnace 86 are omitted from FIGS. 10A and 10B for clarity of illustration.

In the example illustrated in FIG. 10A, two inspection assemblies, identified by reference characters 20A and 20B for convenience, are positioned in the wall “W₁” to obtain preselected information from two selected locations inside the chamber 21 respectively. As can be seen in FIG. 10A, the selected locations are portions of interior surfaces 14′ of the walls “W₁” and the surface 12 of the process material 10. It will be understood that the process material 10 includes the steel bath 88 and slag and/or slag foam 16 thereon and/or therein. As illustrated in FIG. 10A, the inspection devices in the inspection assemblies 20A, 20B respectively have fields of view “FV₁”, “FV₂”. It will be understood that parts of the respective surfaces 12, 14′ of the process material 10 and the wall “W₁” are within the fields of view “FV₁”, “FV₂”.

In one embodiment, the system 80 may be utilized for control of slag foaming, during steelmaking. In this embodiment, the inspection assemblies 20A, 20B preferably are utilized for monitoring the slag foaming in the chamber 21, in and on the surface of the process material 10. As illustrated in FIG. 10A, the slag foaming process is underway at the locations identified by reference characters “S₁”, “S₂”, where slag 16 can be seen.

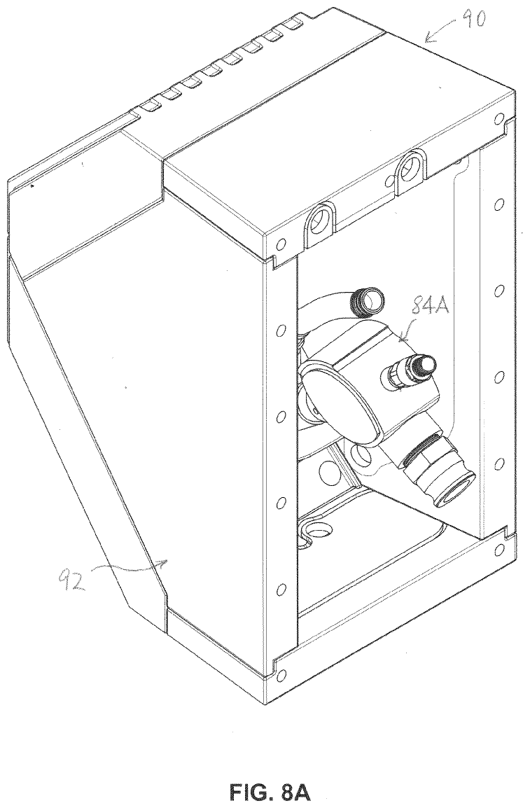

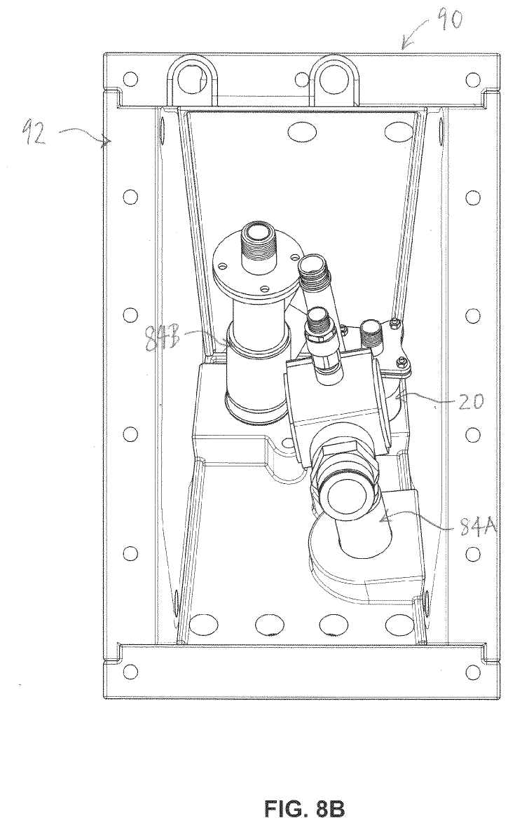

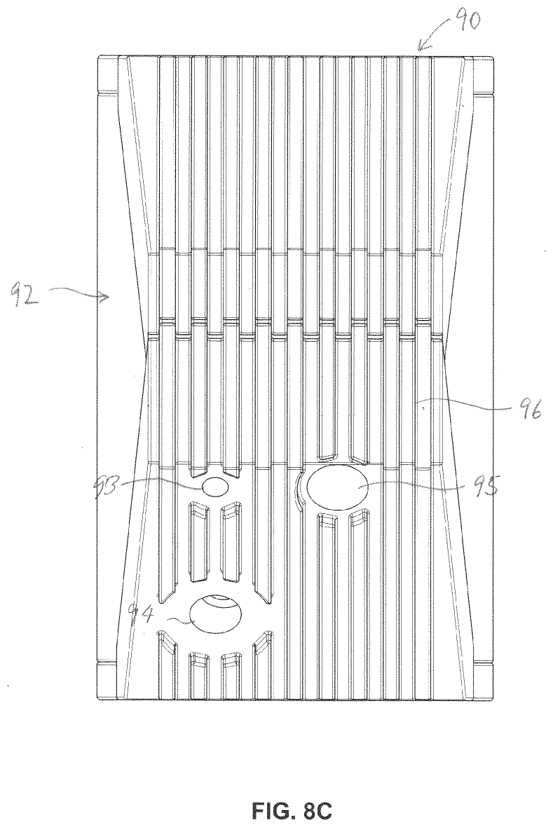

An embodiment of a panel assembly 90 is illustrated in FIGS. 8A-8C. In one embodiment, the panel assembly 90 preferably includes a panel body 92, one or more injector assemblies 84, and one or more inspection assemblies 20 (FIGS. 8A-8C). As can be seen in FIG. 10A, panel assemblies that are mounted in the wall “W₁” are identified for convenience by reference characters 90A, 90B.

In the example illustrated in FIG. 8B, the panel assembly 90 preferably includes one inspection assembly 20, an injector assembly 84A that is a supersonic carbon injector, and an injector assembly 84B that is a variable oxygen flow burner. It will be understood that any suitable injector assemblies may be included in the panel assembly 90. The inspection assembly 20 that is included in the panel assembly 90 may include any suitable inspection device (not shown in FIGS. 8A-8C), e.g., a camera.

It will also be understood that the panel body 92 preferably is water-cooled. As can be seen in FIG. 8C, the panel body 92 preferably includes openings 93, 94, 95 in a front side 96 of the panel body 92. In the panel assembly 90 that is illustrated, the inspection assembly 20 is mounted for alignment with the opening 93, and the injector assemblies 84A, 84B are mounted for alignment with the openings 94, 95.

As illustrated in FIG. 10A, the panel assemblies 90A, 90B preferably are mounted in the wall “W₁” to locate the inspection assemblies 20 positioned therein so that preselected information may be obtained via those inspection assemblies about portions “M₁”, “M₂” of the surface 12 of the process material 10 (i.e., the steel bath 88 and/or the slag 16) that is of interest. (It will be understood that “M₁” and “M₂” are within the respective fields of view of the inspection assemblies that are positioned in the panel assemblies 90A, 90B.) The locations “S₁”, “S₂” (at which slag foaming is underway) generally are within the portions “M₁”, “M₂”. Also, the panel assemblies 90A, 90B are positioned to locate the injector assemblies therein for injection of selected amounts of selected injection agents into the steel bath 88 at the respective locations.

For convenience, the field of view viewable via the inspection assembly included in the panel assembly 90B is identified in FIG. 10B by reference character “FVB”. The injection agent injected into the process material 10 by the injector assembly 84B is schematically represented in FIG. 10B as a generally conical stream of matter (possibly including one or more of solids, liquids, and/or gases) identified for convenience by reference character “D”.

In one embodiment, the preselected information (i.e., one or more actual values of one or more selected parameters) preferably is transmitted from the inspection assemblies in the panel assemblies 90A, 90B to the processor 82. For example, the processor 82 may be configured to utilize a slag foaming control model that enables the operator to set certain values of specific parameters of the slag foaming process that are “ideal”, or desirable, in the circumstances, i.e., within the acceptable range of values thereof. When the preselected information is obtained, that information is processed by the processor 82 to determine whether the actual values for the selected parameters of the actual slag foaming process that is underway at the locations “M₁”, “M₂” are within the acceptable ranges of values thereof.

For example, the slag foaming control model may allow the operator to set the FeO limits (i.e., the predetermined acceptable range of values) as a target to control foaming and also to optimize power utilization or other factors, e.g., time, yield, carbon consumption and oxygen consumption. The model may also be used to predict end point temperature and carbon content.

It will be understood that other inspection assemblies (not shown) may be positioned to obtain information about other selected locations inside the chamber 21. For example, the inspection assemblies 20A, 20B are positioned for obtaining information about the surface 14′ of the wall “W₁”, as well as the surface 12 of the process material 10.

It will be understood that the preselected information provided by other inspection devices preferably is also transmitted to the processor 82, for processing thereof.

From the foregoing, it can be seen that, for example, based on the preselected information obtained for a specific location on the surface 14 of the process material 10, the system 80 may cause selected materials carried by supersonic streams of gases to be injected, to cause desired changes in the process material 10 at that location. As described above, the changes may be effected substantially in real time, very soon after the preselected information is obtained.

The system 80 may function without human input to modify the process, to adjust actual values of preselected parameters to be within the predetermined acceptable range of values. It will be understood that, in one embodiment, the system 80 may function automatically (i.e., without human input), once the ideal values (i.e., the acceptable range of values) of the preselected parameters have been determined. The slag foaming control model noted above is an example of this. It will also be understood that, alternatively, the system 80 may simply provide a recommended course of action to a human operator who must then take further steps, e.g., in order to cause the materials to be injected into the slag.

The preselected information may be provided to the processor constantly (or substantially constantly), or at any suitable intervals. The system 80 has the benefits, among others, of constantly updating slag conditions, and adjusting oxygen and carbon flow rates for optimum results. For example, the system 80 preferably enables the operator to inject carbon on when needed, based on the predicted FeO content. This leads to reduced CO₂ emissions, because the quantity and duration of injected carbon is optimized, and the risk of excessive carbon injection is minimized. The risk of excessive lime injection is also minimized. Preferably, the slag foaming control model provides a real time display of predicted FeO and MgO content.

Other sources of data may be utilized to provide additional information to the processor 82. For example, in the model, predicted carbon and temperature are also preferably adjusted at intervals in view of measured values from temperature and oxygen probes.

It will be understood that various preselected information may be obtained via the inspection assemblies 20A, 20B that may be used for different purposes. For example, with cameras in the inspection assemblies 20A, 20B, the depth of the hot heel remaining in the electric arc furnace (i.e., above the floor “F”) may be determined (FIG. 10A). This can be important because, if too much steel is allowed to remain in the furnace, the furnace may be overcharged subsequently as a result, which may damage the furnace.

It will also be understood that the schematic illustration of the operation of the system 80 in FIG. 9 is idealized and simplified. The processes by which the inspection device (not shown in FIG. 9) gathers the preselected information from the location inside the chamber 21 are represented by outward and inward bound arrows 101, 103 for convenience. It will also be understood that the preselected information is obtained via the annular gas streams, schematically represented by the dashed lines identified by reference characters 105, 107. The transmission of the preselected information from the inspection assembly 20 to the processor 82 is schematically represented by arrow 109. Controlling signals initiated by the processor 82 and directed to the injector assemblies are schematically represented by arrow 111. The materials or fluids (gases) injected into the steel bath 88 at the location “L” are schematically represented by arrow 113 in FIG. 9.

Those skilled in the art would appreciate that the system of the invention may advantageously be utilized, for example, in an operating electric arc furnace in connection with one or more of the following:
monitoring and controlling foaming slag;
detecting scrap;
continuous monitoring of the temperature of the surface of the steel bath;
water leak detection;
hot spot detection;
refractory inspection.

As noted above, the inspection assembly preferably is utilized in a furnace environment. Accordingly, the inspection assembly may be utilized in a high particle impact environment, or in a high temperature environment, or in an environment that is both, in which the inspection assembly may be exposed to both high impact particles and high temperatures.

In summary, the advantages of the inspection assembly 20 include the following. First, the supersonic or approximately supersonic annular gas streams 50, 58 prevent particles from impinging onto the inspection device 22. Second, the acceleration of the gas or gases directed into the annular spaces 44, 52 to supersonic or approximately supersonic velocities cools the barrel subassembly 26. Finally, the separation of the inner and outer barrels 32, 40 by the annular space 44 and the separation of the inner barrel 32 from the inspection device 22 creates an insulation barrier that protects the inspection device 22, and in particular the electronic components of the inspection device 22.

A number of prior art devices are water-cooled. However, with the water-cooled devices, there is a risk that water may leak therefrom, into the chamber, which may be dangerous, e.g., if the water is introduced into the process material 10. Advantageously, the inspection assembly of the invention does not have this risk.

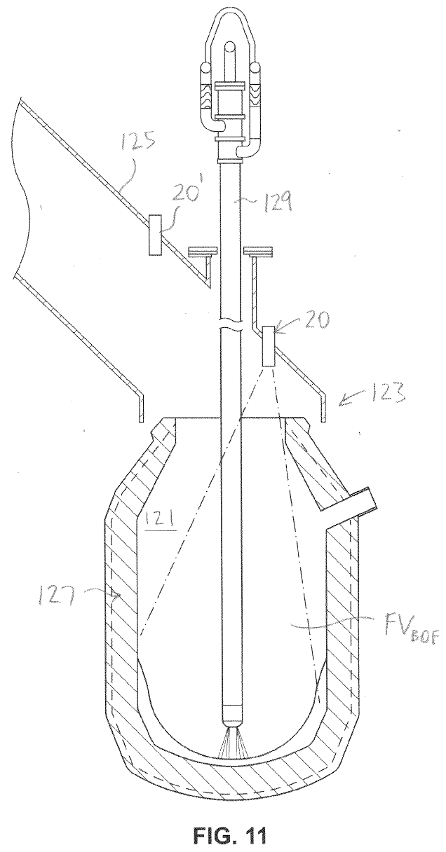

As can be seen in FIG. 11, the inspection assembly 20 may be utilized in a basic oxygen furnace 123. In the example illustrated in FIG. 11, the inspection assembly 20 is mounted in a fume collection hood 125 of the furnace 123. It will be understood that elements of the basic oxygen furnace are omitted from FIG. 11 for clarity of illustration. The inspection assembly 20 may include any suitable inspection device or sensor, for instance, one of the following inspection devices (not shown in FIG. 11): an infrared camera, a color camera, and a microwave or laser.

The infrared camera may be used for leak detection, for slag height measurement, and for measuring temperature of the slag and of refractory.

The color camera may be used to analyze slag before slag splashing, and as a light meter, to determine end of blow.

The microwave or laser may be used to measure slag height and to detect slopping.

In addition, or instead of the inspection assembly 20, another inspection assembly (identified in FIG. 11 by reference character 20′ for convenience may be positioned elsewhere in the fume hood, in which a temperature sensor may be mounted. The temperature sensor may be used to determine temperature, to determine end of blow.

The basic oxygen furnace 123 includes a shell 127. During operation, a water-cooled lance 129 is positioned partly in the shell 127. In the examples illustrated, a chamber 121 is defined inside the shell 127, and partly inside the fume collection hood 125.

As illustrated in FIG. 11, the inspection device that is in the inspection assembly 20 has a field of view “FVBOF”. Annular gas streams directed from the inspection assemblies 20, 20′ are omitted from FIG. 11 for clarity of illustration. The inspection devices or sensors that may be included in the inspection assembly 20 may be used, for example, for one or more of the following:
measuring bottom buildup;
measuring slag temperature before and after slag splashing;
measuring slag height and rate of rise of slag height, to detect slopping;
controlling the lance height (i.e., lance positioning) to control slag generation and reduce slopping;
detecting water leaks;
detecting lance skull build up during the heat;
detecting converter cone and mouth build up;
measuring and quantifying the post-combustion reaction zone;
determining the end of blow (with light meter and/or temperature sensor);
monitoring ignition;
monitoring and controlling flux additions.

It will be understood that the inspection assemblies 20, 20′ that are mounted in the fume collection hood 125 of the basic oxygen furnace may be included in a system (not shown) in which the inspection assemblies 20, 20′ preferably are operatively connected with a processor (not shown in FIG. 11) that may control injection assemblies (not shown) for injecting one or more selected injection agents into the process material in the shell 127 for modifying the process that is underway.

Those skilled in the art would appreciate that the inspection assembly 20 and the inspection assembly 20′ have the advantage over the prior art that the inspection devices positioned therein can withstand the high temperatures and the high impact particles, and so may be used for continuously monitoring the process inside the basic oxygen furnace 123.

It will be appreciated by those skilled in the art that the invention can take many forms, and that such forms are within the scope of the invention as claimed. The scope of the claims should not be limited by the preferred embodiments set forth in the examples, but should be given the broadest interpretation consistent with the description as a whole.

1. An inspection assembly for obtaining preselected information in a furnace environment in a chamber in which a process material is subjected to a process, the inspection assembly comprising:
at least one inspection device for detecting the preselected information, said at least one inspection device defining an aperture through which the preselected information is detectable;
a barrel subassembly extending between first and second ends thereof, the barrel subassembly comprising:
an inner barrel having a first wall defining an inner bore, and a second wall located radially outwardly relative to the first wall;
an outer barrel positioned coaxially with the inner barrel, the outer barrel having an inside wall that defines at least one outer annular space between the second wall and the inside wall of the outer barrel, said at least one outer annular space extending between outer upstream and outer downstream ends thereof;
said at least one inspection device being located at least partially inside the inner barrel to at least partially align the aperture thereof with the inner bore, wherein the preselected information is obtainable via said at least one inspection device through the inner bore;
the second end of the barrel subassembly being located to position said at least one outer annular space and the inner bore respectively in fluid communication with the chamber; and
the barrel subassembly being configured for directing a first portion of at least one gas through said at least one outer annular space at at least one preselected velocity to cool the inspection assembly, wherein the first portion of said at least one gas forms an outer annular gas stream coaxial with the inner bore upon exiting from the outer downstream end, and wherein the preselected information is obtainable via the aperture and through the inner bore.

2. The inspection assembly according to claim 1 in which:
the barrel subassembly defines at least one inner annular space between the first wall and said at least one inspection device extending between inner upstream and inner downstream ends thereof; and
the second end of the barrel subassembly is located to position said at least one inner annular space in fluid communication with the chamber,
the barrel subassembly being configured for directing a second portion of said at least one gas through said at least one inner annular space at said at least one preselected velocity to cool the inspection assembly, said at least one gas that is directed through said at least one inner annular space forming an inner annular gas stream coaxial with the inner bore upon exiting from the inner downstream end, wherein the preselected information is obtainable via the aperture and through the inner bore.

3. The inspection assembly according to claim 2 in which the inspection device is selected from the group consisting of a camera, a microwave unit, a laser, and a temperature sensor.

4. A system for modifying a process to which a process material is subjected in a furnace environment in a chamber, to adjust at least one actual value of at least one preselected parameter of the process to a predetermined acceptable range of values of said at least one preselected parameter, the system comprising:
an inspection assembly as claimed in claim 1;
a processor, for processing the preselected information to determine, based on the preselected information, whether said at least one actual value of said at least one preselected parameter of the process is within the predetermined acceptable range of values thereof, and if said at least one actual value of said at least one preselected parameter is not within the predetermined acceptable range of values thereof, then the processor determines a selected amount of a selected injection agent to be injected into the process material, to adjust said at least one actual value of said at least one predetermined parameter to the predetermined acceptable range of values thereof; and
at least one injector assembly, for injecting the selected amount of the selected injection agent into the process material to adjust said at least one actual value of said at least one preselected parameter to the acceptable range of values thereof.

5. The system according to claim 4 in which:
the barrel subassembly defines at least one inner annular space between the first wall and said at least one inspection device extending between inner upstream and inner downstream ends thereof; and
the second end of the barrel subassembly is located to position said at least one inner annular space in fluid communication with the chamber,
the barrel subassembly being configured for directing a second portion of said at least one gas through said at least one inner annular space at said at least one preselected velocity to cool the inspection assembly, wherein said at least one gas that is directed through said at least one inner annular space forms an inner annular gas stream coaxial with the inner bore upon exiting from the inner downstream end, wherein the preselected information is obtainable via the aperture and through the inner bore.

6. A method of obtaining preselected information in a furnace environment in a chamber in which a process material is subjected to a process, the method comprising the steps of:
(a) providing an inspection assembly comprising:
at least one inspection device for obtaining the preselected information, said at least one inspection device defining an aperture through which the preselected information is obtainable;
a barrel subassembly extending between first and second ends thereof, the barrel subassembly comprising:
an inner barrel having a first wall defining an inner bore, and a second wall located radially outwardly relative to the first wall;
an outer barrel positioned coaxially with the inner barrel, the outer barrel having an inside wall that defines at least one outer annular space between the second wall and the inside wall of the outer barrel, said at least one outer annular space extending between outer upstream and outer downstream ends thereof;
said at least one inspection device being located at least partially inside the inner barrel to at least partially align the aperture thereof with the inner bore, wherein the preselected information is obtainable via the aperture and through the inner bore;
(b) locating the second end of the barrel subassembly to position said at least one outer annular space in fluid communication with the chamber;
(c) directing a first portion of at least one gas through said at least one outer annular space at at least one preselected velocity to cool the inspection assembly, said at least one gas forming an outer annular gas stream coaxial with the inner bore upon exiting from the outer downstream end; and
(d) obtaining the preselected information through the aperture, via the inner bore.

7. The method according to claim 6 in which said at least one inspection device is selected from the group consisting of a camera, a microwave unit, a laser, and a temperature sensor.

8. The method according to claim 6 additionally comprising:
(e) transmitting the preselected information obtained by the inspection device to a processor; and
(f) with the processor, processing the preselected information to determine, based on the preselected information, whether at least one actual value of at least one preselected parameter of the process is within a predetermined acceptable range of values thereof.

9. The method according to claim 6 in which:
the barrel subassembly defines at least one inner annular space between the first wall and said at least one inspection device extending between inner upstream and inner downstream ends thereof;
the second end of the barrel subassembly is located to position said at least one inner annular space in fluid communication with the chamber; and
a second portion of said at least one gas is directed through said at least one inner annular space at the preselected velocity to cool the inspection assembly, said at least one gas that is directed through said at least one inner annular space forming an inner annular gas stream coaxial with the inner bore upon exiting from the inner downstream end, wherein the preselected information is obtainable via the aperture and through the inner bore.

10. The method according to claim 6 in which said at least one preselected velocity is supersonic.

11. The method according to claim 6 in which said at least one preselected velocity is subsonic.

12. The method according to claim 6 additionally comprising:
(e) transmitting the preselected information obtained by said at least one inspection device to a processor, for processing thereof to determine, based on the preselected information, whether said at least one actual value of said at least one preselected parameter of the process is within the predetermined acceptable range of values thereof;
(f) providing at least one injector assembly controlled by the processor, for injecting a selected amount of a selected injection agent into the process material; and
(g) if said at least one actual value of said at least one preselected parameter is not within the predetermined acceptable range of values thereof, then:
with the processor, determining the selected amount of the selected injection agent to be injected into the process material, to adjust said at least one actual value of said at least one predetermined parameter to the predetermined acceptable range of values thereof, and
with said at least one injector assembly, injecting the selected amount of the preselected injection agent into the process material, to adjust said at least one preselected parameter at least toward the acceptable range of values thereof.

13. The method according to claim 12 in which:
the barrel subassembly defines at least one inner annular space between the first wall and said at least one inspection device, extending between inner upstream and inner downstream ends thereof;
the second end of the barrel subassembly is located to position said at least one inner annular space in fluid communication with the chamber; and
a second portion of said at least one gas is directable through said at least one inner annular space at said at least one preselected velocity to cool the inspection assembly, said at least one gas that is directed through said at least one inner annular space forming an inner annular gas stream coaxial with the inner bore upon exiting from the inner downstream end, wherein the preselected information is obtainable via the aperture and through the inner bore.

14. The inspection assembly according to claim 2 in which the barrel subassembly comprises a first plug element positioned to prevent the first portion of said at least one gas from moving through said at least one outer annular space.

15. The inspection assembly according to claim 2 in which the barrel subassembly comprises a second plug element positioned to prevent the second portion of said at least one gas from moving through said at least one inner annular space.

16. An inspection assembly for obtaining preselected information in a furnace environment in a chamber in which a process material is subjected to a process, the inspection assembly comprising:
at least one inspection device for detecting the preselected information, said at least one inspection device defining an aperture through which the preselected information is detectable;
a barrel subassembly extending between first and second ends thereof, the barrel subassembly comprising:
an inner barrel having a first wall defining an inner bore, and a second wall located radially outwardly relative to the first wall;
an outer barrel positioned coaxially with the inner barrel;
the barrel subassembly defining at least one inner annular space between the first wall and said at least one inspection device extending between inner upstream and inner downstream ends thereof;
said at least one inspection device being located at least partially inside the inner barrel to at least partially align the aperture thereof with the inner bore, wherein the preselected information is obtainable via said at least one inspection device through the inner bore;
the second end of the barrel subassembly is located to position said at least one inner annular space and the inner bore respectively in fluid communication with the chamber; and
the barrel subassembly being configured for directing at least one gas through said at least one inner annular space at at least one preselected velocity to cool the inspection assembly, wherein said at least one gas forms an inner annular gas stream coaxial with the inner bore upon exiting from the outer downstream end, and wherein the preselected information is obtainable via the aperture and through the inner bore.

17. A system for modifying a process to which a process material is subjected in a furnace environment in a chamber, to adjust at least one actual value of at least one preselected parameter of the process to a predetermined acceptable range of values of said at least one preselected parameter, the system comprising:
an inspection assembly as claimed in claim 16;
a processor, for processing the preselected information to determine, based on the preselected information, whether said at least one actual value of said at least one preselected parameter of the process is within the predetermined acceptable range of values thereof, and if said at least one actual value of said at least one preselected parameter is not within the predetermined acceptable range of values thereof, then the processor determines a selected amount of a selected injection agent to be injected into the process material, to adjust said at least one actual value of said at least one predetermined parameter to the predetermined acceptable range of values thereof; and
at least one injector assembly, for injecting the selected amount of the selected injection agent into the process material to adjust said at least one actual value of said at least one preselected parameter to the acceptable range of values thereof.

18. A method of obtaining preselected information in a furnace environment in a chamber in which a process material is subjected to a process, the method comprising the steps of:
(a) providing an inspection assembly comprising:
at least one inspection device for obtaining the preselected information, said at least one inspection device defining an aperture through which the preselected information is obtainable;
a barrel subassembly extending between first and second ends thereof, the barrel subassembly comprising:
an inner barrel having a first wall defining an inner bore, and a second wall located radially outwardly relative to the first wall;
an outer barrel positioned coaxially with the inner barrel, the barrel subassembly defining at least one inner annular space between the first wall and said at least one inspection device extending between inner upstream and inner downstream ends thereof;
said at least one inspection device being located at least partially inside the inner barrel to at least partially align the aperture thereof with the inner bore, wherein the preselected information is obtainable via the aperture and through the inner bore;
(b) locating the second end of the barrel subassembly to position said at least one inner annular space in fluid communication with the chamber;
(c) directing at least one gas through said at least one outer annular space at at least one preselected velocity to cool the inspection assembly, said at least one gas forming an inner annular gas stream coaxial with the inner bore upon exiting from the outer downstream end; and
(d) obtaining the preselected information through the aperture, via the inner bore.
